(19) United States
(12) Patent Application Publication
(10) Pub. No.: US 2008/0256127 A1
(43) Pub. Date: Oct. 16, 2008

(54) System For Extracting Specific Portions of Contents

(76) Inventors: Chung-tae Kim, Gyeonggi-do (KR); Hyun-Jong Sung, Seoul (KR); Kook-hyung Cho, Gyeonggi-do (KR)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 10/593,125

(22) PCT Filed: Apr. 21, 2004
(86) PCT No.: PCT/KR2004/000915

§ 371 Date: Sep. 18, 2006

(30) Foreign Application Priority Data
Mar. 23, 2004 (KR) 10-2004-0019728

(51) Int. Cl. G06F 17/30

(52) U.S. Cl. 707/104.1; 707/E17.028; 707/E17.057

(57) ABSTRACT

The present invention relates to a system for extracting a specific portion of content. When a desired portion is extracted so that a content service can be provided, a plurality of users extract a beginning time and an ending time of a specific frame in the case of moving picture content and carry out a temporal indexing operation. When searching for the specific portion after extracting a beginning point and an ending point of the specific portion in case of still picture content and carrying out a spatial indexing operation, the plurality of users retrieve and display the specific portion from an indexed database. Therefore, the plurality of users can carry out the indexing operation for one file to organize a search database without correcting an original file and can extract the specific portion of content. Moreover, because the specific portion of content can be extracted and the extracted specific portion can be displayed and edited, all file formats can be controlled irrespective of file format.

### TECHNICAL FIELD

The present invention relates to a system for extracting a specific portion of content, and more particularly to a system for extracting a specific portion of content that will allow a plurality of users to extract the beginning time and ending time of a specific frame, in the case of moving picture content and carry out a temporal indexing operation when a specific portion is extracted so that a content service can be provided, and to retrieve and display the specific portion from an indexed database when searching for the specific portion after extracting a beginning point and an ending point of the specific portion and carry out a spatial indexing operation, such that a plurality of users can carry out the indexing operation for one file to organize a search database without correcting the original file and can extract the specific portion of content.

### BACKGROUND ART

Content provided through current wired/wireless communication mostly includes moving picture content and still picture content. The moving picture content or still picture content is sent from the beginning to the end in a unit of a file.

In order for an intermediate portion of the moving picture content to be viewed, a search bar is shifted to a corresponding portion in a player. In this case, it is difficult for the corresponding portion to be correctly searched for. Similarly, in order to review a corresponding portion, a user must search for the corresponding portion while shifting the search bar.

On the other hand, a key frame scheme is used for selecting or extracting a key image and viewing a desired portion using the selected or extracted key image. However, there is a problem in that the key frame scheme is not correct.

In the case of still picture content, the user shifts the search bar to a corresponding portion to view an intermediate portion of a still picture file, but cannot correctly search for the intermediate portion.

A method for extracting only user-desired information based on a user's information request to display the extracted information is disclosed in “Method for organizing database based on information modeling and retrieving information from organized database” filed with the Korean Intellectual Property Office on Jun. 9, 2000 by the applicant and assigned U.S. Pat. No. 0,407,033 on Nov. 28, 2003. In the above-described method, when the user makes a request for various information units such as historical information, industrial information, document materials, learning material, video information, etc., a user terminal is connected to a database containing various information units. Analysis and modelling operations for semantic elements such as temporal data, spatial data, temporal-spatial data, situation name, keyword, etc., inputted by the user, are carried out. A relative situation, module, action, etc. are retrieved from a database organized through the analysis and modelling operations. In the above patent, there is disclosed a method for organizing the database to retrieve information from the organized database so that user-desired information is extracted and the probability of retrieving the user-selected information is enhanced.

Accordingly, in order that the above method can be effectively implemented, a need exists for a system that can carry out analysis and modelling operations for semantic elements inputted by a plurality of users without correcting a moving picture file and a still picture file in temporal and spatial domains and can extract specific portions of the moving picture file and the still picture file.

### DISCLOSURE OF THE INVENTION

Therefore, the present invention has been made in view of the above need, and it is an object of the present invention to provide a system for extracting a specific portion of content that can allow a plurality of users to extract a beginning time and an ending time of a specific frame in case of moving picture content and carry out a temporal indexing operation when a desired specific portion is extracted so that a content service can be provided, and to retrieve and display the specific portion from an indexed database when searching for the specific portion after extracting a beginning point and an ending point of the specific portion in the case of still picture content and carrying out a spatial indexing operation, such that the plurality of users can carry out the indexing operation for one file to organize a search database without correcting the original file and can extract the specific portion of content.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a system for extracting a specific portion of content in accordance with the present invention;

FIG. 2 shows a process for extracting a predetermined time interval of moving picture content in accordance with the present invention; and

FIG. 3 shows a process for extracting a predetermined interval of still picture content in accordance with the present invention.

### BEST MODE FOR CARRYING OUT THE INVENTION

In accordance with an aspect of the present invention, the above and other objects can be accomplished by the provision of a system for extracting a specific portion of content, comprising: a content management database for registering at least one content file to be served and storing address and price information of the content file to be served; a temporal controller for designating a beginning time and an ending time in each time interval of a moving picture stored in the content management database, extracting the time interval and reproducing and terminating the moving picture according to the beginning time and the ending time in the extracted time interval; a spatial controller for designating a starting point and an ending point in each space interval of the file stored in the content management database, extracting the space interval and displaying a portion of the file according to the beginning point and the ending point of the extracted space interval; and a content search database for storing not only search indexes and description materials but also integrated information of the search indexes and description materials so that the time interval extracted through the temporal controller can be retrieved according to the streaming of moving picture content and the space interval extracted through the spatial controller can be retrieved according to a display portion of still picture content.

Preferably, the moving picture content is based on various file formats such as Windows Media, Real Time, Quick Time, MPEG (Moving Picture Experts Group) 1/2/4/7/21, etc.

Preferably, the still picture content is based on various file formats such as text, graphic, image, HTML (Hypertext Markup Language), XML (Extensible Markup Language), etc.

According to the above-described aspect of the present invention, the temporal controller extracts a specific time interval based on the beginning time and ending time corresponding to a specific portion in case of the moving picture content, or the spatial controller extracts a specific space interval based on a beginning point and an ending point corresponding to a specific portion in case of the still picture content. A plurality of users carry out an indexing operation for one content without correcting the file and store a result of the indexing operation in the content search database, such that a specific portion of content can be searched for and only the specific portion can be served.

Now, preferred embodiments of the present invention will be described in detail with reference to the annexed drawings. The preferred embodiments are not intended to limit the scope of the present invention.

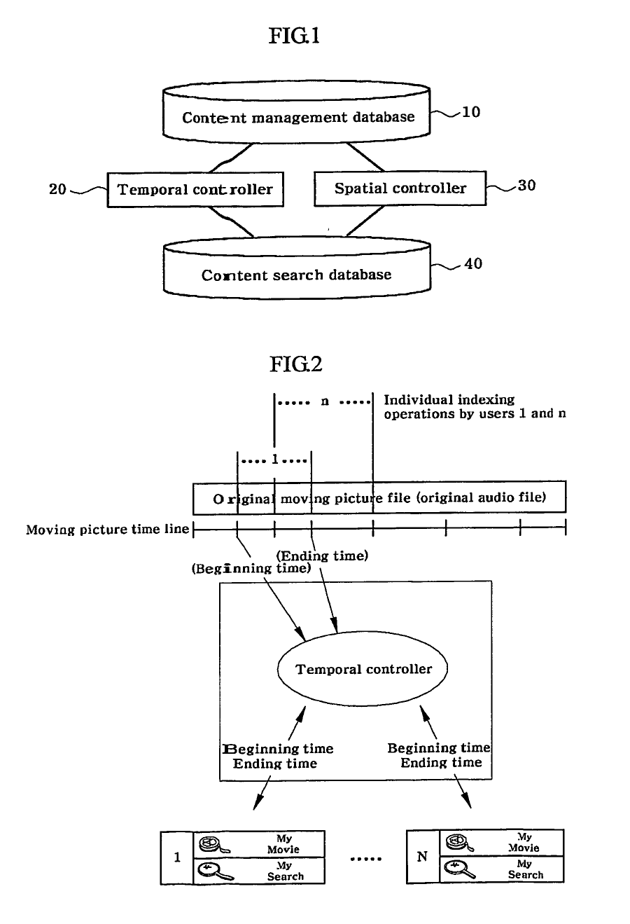

FIG. 1 is a block diagram illustrating a system for extracting a specific portion of content in accordance with the present invention.

As shown in FIG. 1, a content management database 10 registers at least one content file to be served and stores address and price information of the content file to be served. A temporal controller 20 designates a beginning time and an ending time in each time interval of a moving picture stored in the content management database 10, extracts the time interval, and reproduces and terminates the moving picture according to the beginning time and the ending time of the extracted time interval. A spatial controller 30 designates a starting point and an ending point in each space interval of the file stored in the content management database 10, extracts the space interval, and displays a portion of the file according to the beginning point and the ending point of the extracted space interval. A content search database 40 stores not only search indexes and description materials but also integrated information of the search indexes and description materials so that the time interval extracted through the temporal controller 20 can be retrieved according to the streaming of moving picture content and the space interval extracted through the spatial controller 30 can be retrieved according to a display portion of the still picture content.

A predetermined time interval of the moving picture content based on various file formats such as Windows Media, Real Time, Quick Time, MPEG (Moving Picture Experts Group) 1/2/4/7/21, etc. stored in the content management database 10 can be served. A predetermined space interval of the still picture content based on various file formats such as text, graphic, image, HTML (Hypertext Markup Language), XML (Extensible Markup Language), etc. stored in the content management database 10 can be served. Different portions of the same content can be stored according to a plurality of different users. In this case, the content of the predetermined time interval and content of the predetermined space interval are extracted and the extracted contents are stored in the content search database 40.

Where the predetermined time interval of moving picture content stored in the content management database 10 is extracted, the temporal controller 20 extracts the beginning time of the predetermined time interval when the user selects the beginning portion of the predetermined time interval while viewing a moving picture file. Subsequently, when a user selects the ending portion of the predetermined time interval, the temporal controller 20 extracts the ending time of the predetermined time interval. Subsequently, when the user inputs a search word, a keyword, a title, or related information, various information units necessary for a search operation as well as the beginning and ending times of the predetermined time interval are indexed and a result of the indexing is stored in the content search database 40.

The user allows the temporal controller 20 to extract the predetermined time interval based on the beginning and ending times corresponding to a frame while viewing a moving picture on the Internet in a state where an original moving picture file is not corrected, such that a plurality of users can carry out an indexing operation for one file.

When users 1 and n select a desired portion on a time line while viewing the original moving picture file, as shown in FIG. 2, the beginning and ending times of the corresponding portion are extracted. The content search database 40 stores not only the beginning and ending times of the predetermined time interval but also information necessary for a search operation user by user.

As described above, because the beginning and ending times are extracted and then the predetermined time interval is extracted, all file formats can be controlled irrespective of a file format of a moving picture. That is, the beginning and ending times are extracted, the predetermined time interval is extracted and information indicating a result of the extracting is stored in the database, irrespective of various file formats such as Windows Media, Real Time, Quick Time, MPEG (Moving Picture Experts Group) 1/2/4/7/21, etc. The temporal controller 20 begins to reproduce content of the selected time interval at the beginning time and terminates a playback operation at the ending time according to temporal information, such that only the content of the predetermined time interval can be reproduced.

When a predetermined space interval of still picture content stored in the content management database 10 is extracted, the spatial controller 30 extracts a beginning point of the predetermined space interval when the user selects the beginning point of the predetermined time interval while viewing a still picture file. Subsequently, when the user selects an ending point of the predetermined space interval, the spatial controller 30 extracts the ending point of the predetermined time interval. Subsequently, when the user inputs a search word, a keyword, a title, related information, etc., various information units necessary for a search operation as well as the beginning and ending points of the predetermined space interval are indexed and a result of the indexing is stored in the content search database 40.

The user allows the spatial controller 30 to extract the predetermined space interval based on the beginning and ending points corresponding to a specific portion of a document while viewing a still picture on the Internet in a state where an original still picture file is not corrected, such that the plurality of users can carry out an indexing operation for one file.

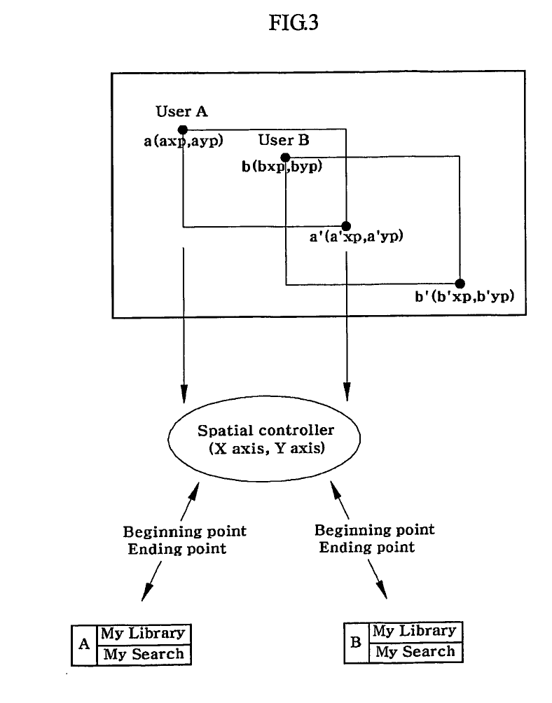

That is, when users a and b select a desired portion within a file while viewing the original still picture file as shown in FIG. 3,the beginning and ending points of a corresponding space interval are extracted. The content search database 40 stores not only the beginning and ending points of the predetermined space interval but also information necessary for the search operation user by user.

The spatial controller 30 extracts the beginning point a(axp, ayp) and ending point a′(a′xp, a′yp) from the predetermined space interval selected by the user a with respect to the still picture file stored in the content management database 10. The spatial controller 30 stores, in the content search database 40, information necessary for searching for the beginning and ending points of the predetermined space interval user by user together with the result of the extraction. Moreover, the spatial controller 30 extracts a beginning point b(bxp, byp) and an ending point b′(b′xp, b′yp) from the predetermined space interval selected by the user b with respect to the still picture file stored in the content management database 10. The spatial controller 30 stores, in the content search database 40, information necessary for searching for the beginning and ending points of the predetermined space interval user by user together with the result of the extraction.

As described above, because the beginning and ending points are extracted and then the predetermined space interval is extracted, all file formats can be controlled irrespective of the file format of the still picture content. That is, only the beginning and ending points in a corresponding file are extracted, the predetermined space interval is extracted and information indicating the result of the extracting is stored in the database, irrespective of various file formats such as text, graphic, image, HTML (Hypertext Markup Language), XML (Extensible Markup Language), etc. The spatial controller 30 begins to display content of the beginning and ending points according to spatial information, such that only the content of the predetermined space interval can be edited at searched points.

Where content based on the same format as at the time of selling the content is served using a system for extracting a specific portion of content, an indexing operation for a specific portion of a content stream or document is carried out and hence a desired portion can be retrieved from the total content. A corresponding portion is extracted and the extracted portion is served through the wired/wireless Internet. When the corresponding portion is extracted, a search word is added to the indexing operation, such that moving picture content or still picture content can be correctly searched for. Only a part of the content file rather than the total of the content file is extracted and the extracted part of the content file can be cost-effectively served through the wired/wireless Internet, such that content transaction and service can be promoted on line.

### INDUSTRIAL APPLICABILITY

As apparent from the above description, the present invention provides a system for extracting a specific portion of content that can allow a plurality of users to extract a beginning time and an ending time of a specific frame in case of moving picture content and carry out a temporal indexing operation when a desired specific portion is extracted so that a content service can be provided, and to retrieve and display the specific portion from an indexed database when searching for the specific portion after extracting a beginning point and an ending point of the specific portion in case of still picture content and carrying out a spatial indexing operation, such that a plurality of users can carry out the indexing operation for one file to organize a search database without correcting the original file and can extract the specific portion of content.

Moreover, because beginning and ending times can be extracted in case of moving picture content so that a predetermined time interval is extracted and content of the extracted time interval is displayed and edited or the beginning and ending points can be extracted in case of still picture content so that a predetermined space interval is extracted and content of the extracted space interval is displayed and edited, all file formats can be controlled irrespective of file format.

1. A system for extracting a specific portion of contents, comprising:
a content management database for registering at least one content file to be served and for storing address and price information of the content file to be served;
a temporal controller for designating a beginning time and an ending time in each time interval of a moving picture stored in the content management database, extracting the time interval and reproducing and terminating the moving picture according to the beginning time and the ending time of the extracted time interval;
a spatial controller for designating a starting point and an ending point in each space interval of the file stored in the content management database, extracting the space interval and displaying a portion of the file according to the beginning point and the ending point of the extracted space interval; and
a content search database for storing not only search indexes and description materials but also integrated information of the search indexes and description materials so that the time interval extracted through the temporal controller can be retrieved according to the streaming of moving picture content and the space interval extracted through the spatial controller can be retrieved according to a display portion of the still picture content.

2. The system according to claim 1, wherein the moving picture content is based on one of file formats selected from the group consisting of Windows Media, Real Time, Quick Time, or MPEG (Moving Picture Experts Group) 1/2/4/7/21.

3. The system according to claim 1, wherein the still picture content is based on one of file formats selected from the group consisting of text, graphic, image, HTML (Hypertext Markup Language), or XML (Extensible Markup Language).
